(19) United States
(12) Patent Application Publication
(10) Pub. No.: US 2011/0303738 A1
(43) Pub. Date: Dec. 15, 2011

(54) FOLDABLE MULTI-ROW TRAY

(75) Inventors: Fred FOUSHEE, Suwanee, GA (US); Richard Pete RIVARD, Osceola, WI (US)

(73) Assignee: Rock-Tenn Shared Services LLC, Norcross, GA (US)

(21) Appl. No.: 13/156,972

(22) Filed: Jun. 9, 2011

Related U.S. Application Data
(60) Provisional application No. 61/354,044, filed on Jun. 11, 2010.

(51) Int. Cl. B65D 5/484; B31B 1/62; B31B 1/26; B31B 1/10

(52) U.S. Cl. 229/120.24; 229/174; 229/198; 493/127; 493/128

(57) ABSTRACT

Embodiments of the present invention provide multi-row trays that are formed from paperboard in order to present an environmentally-friendly, effective storage option for items.

### CROSS REFERENCE TO RELATED APPLICATIONS

This application claims the benefit of U.S. Provisional Application Ser. No. 61/354,044, filed Jun. 11, 2010, titled “Paperboard Tray”, the entire contents of which are hereby incorporated by reference.

### FIELD OF THE INVENTION

Embodiments of the present invention relate generally to trays for use in packaging products. One specific embodiment relates to a multi-row tray. Further embodiments relate to foldable trays made from paperboard material.

### BACKGROUND

Consumer products are often packaged in trays having multiple rows for placement of items. For example, food articles (such as cookies, crackers, biscotti, snacks, confections, or other individual food items to be stacked and separated) may often be packaged in a multi-row tray, with the tray wrapped or otherwise enclosed in a cellophane wrap or other package wrap for shelving. Currently, multi-row trays are traditionally formed of plastic, which have a number of drawbacks. For example, the manufacture of plastic trays uses petroleum, a non-renewable resource, whose costs is volatile. Another drawback to the use of plastic trays is their pre-formed nature, which requires that they be shipped to the client nested together in corrugated shipping containers. Plastic trays are also not typically recyclable.

Further, plastic trays are limited in their ability to be personalized using promotional printing and other branding methods on the surface of the tray. For example, if a consumer purchases cookies that have been packaged in a plastic tray, it is unlikely that the consumer will present the cookies on a buffet table in the original plastic tray, but will instead position the cookies on a more attractive platter and throw the plastic tray away. This is wasteful and presents a lost opportunity for advertising or other marketing. There is this a need for a more eco-friendly packaging option that can also present printing and/or marketing opportunities that are also aesthetically pleasing, if desired.

### BRIEF SUMMARY

Embodiments of the invention described herein thus provide a foldable tray that is formed of a paper-type material such as paperboard, and in a specific embodiment, the tray is formed from a single piece of paperboard that has been cut and designed with pre-formed folds or creases. The nature of the tray allows for shipping the tray to the consumer in a collapsed or flat position, which simplifies shipping and lowers shipping costs due to the lower volume occupied. The use of paperboard is advantageous over the current plastic trays being used because paperboard uses a renewable resource, is more environmentally friendly, and offers opportunities for promotional printing directly on the tray.

### BRIEF DESCRIPTION OF THE DRAWINGS

FIG. 1 shows a top plan view of a blank that may be used to form a three-row tray embodiment of the invention.

FIG. 2 shows a side perspective view of the blank of FIG. 1 in a partially folded configuration.

FIG. 3 shows a side perspective view of the blank of FIG. 1 in an almost completely folded configuration.

FIG. 4 shows a folded tray made from the blank of FIG. 1 with graphics printed thereon.

FIG. 5 shows a top plan view of an alternate blank that may be used to form a tray according to an embodiment of the invention.

FIG. 6 shows a top plan view of an alternate blank that may be used to form a two-row tray.

FIG. 7 shows a top plan view of an alternate blank having varied features that may be used to form a two-row tray.

FIG. 8 shows a top plan view of a further blank having varied features that may be used to form a two-row tray.

### DETAILED DESCRIPTION

Embodiments of the present invention provide a foldable tray that can be used to contain food or other items that are preferably sold or stored in stacked and divided configurations. The most common usage for such a tray is to contain cookies, crackers, or confectionary items that are housed in an inner container that is covered by a separate outer wrap. However, it should be understood that divided trays can provide any number of uses, for example, housing items to be stacked on a store shelf, on countertops at the point of sale, to provide an organizational function for desktops and other surfaces, for easy household storage of items, such as paperclips and pushpins (and on a larger scale, for drawer organization for lingerie items, socks, and so forth), as an easy and disposable way to store items during travel and packing, or any number of uses that may lend themselves to a divided, multi-row tray.

Embodiments of the trays described herein provide an easy way to design and assemble a multi-row tray. Certain specific embodiments provide a two-row tray and others provide a three-row tray. It should be understood, however, that the concepts disclosed herein can be scaled to provide trays with more than three rows in the tray, such as four, five, six, seven, eight, nine, ten rows, or even more rows. These options are limited only by re-tooling considerations and expenses for increasing the scalability of the trays. It should also be understood that if trays having more rows are needed, it is possible to position or secure two or more multi-row trays together so that the equipment does not need to be completely re-tooled in order to provide trays having more rows. For example, if a six-row tray is desired, it is possible to position, glue, or otherwise secure two three-row trays together. It should also be understood that although the embodiments of the trays are typically sized to be about the size of a cookie container on a store shelf, they may be enlarged substantially to hold larger items (e.g., shirts at the point of sale or for packing and storage), or they may be made on a smaller scale to hold smaller items (e.g., paperclips, rubber band, hair care items, make-up or any other appropriate item for sale or storage).

FIG. 1. shows one embodiment of a blank 10 that may be provided in a pre-creased configuration such that it may be easily folded and assembled in order to create a multi-row tray. In the embodiment shown, blank 10 has nine longitudinal panels. Three of the panels are bottom panels 12, 14, 16 and four of the panels are inner panels 18, 20, 22, 24. The bottom panel 14 in the middle of the blank is generally separated by two sets of inner panels. Extending on the outer sides of the bottom panels closest to the edges of the blank (panels 12 and 16), positioned at the outside edges of the blank 10 are two outer side panels 26, 28. Outer side panels 26, 28 form the side walls of the tray once assembled.

The above-described panels may all be similarly sized or the bottom panels may be slightly wider than the other panels. Exemplary sizes may be about 0.5 inches wide or less, up to about 3 or 4 inches wide, about 6 inches wide, or even wider, depending upon the ultimate use of the tray. In a specific embodiment, the bottom panels may be slightly wider than the other panels in order to provide a larger base for the tray. Regarding panel length, the panels may be about 7 inches long of less, up to about 12 inches long, about 16 inches long, or even longer, depending upon the ultimate use of the tray. One specific example of dimensions for the panels may be inner panels and outer side panels being about 1.5 inches wide, the bottom panels being about 1.75 inches wide, and all of these panels being about 10.5 inches long. The end walls (described below) may be about 1.75 inches by about 1.75 inches (e.g., square) and the glue flaps may be about 1.5 inches wide by about one inch long. These dimensions are particularly useful for a tray designed to hold cookies or other food items in a wrapper and to be placed on a store shelf.

Another specific example of dimensions for the panels may be inner panels and outer side panels being about 3 inches wide, the bottom panels being about 3.5 inches wide, and all of these panels being about 16 inches long. The end walls may be about 3.5 inches by about 3.5 inches (e.g., square) and the glue flaps may be about 3.5 inches wide by about two inches long.

Further, the bottom panels need not all be the same size. It may be desirable to provide a tray having a larger middle portion than the other portions, so that the middle bottom panel with be larger than the other bottom panels. Any other options may be provided.

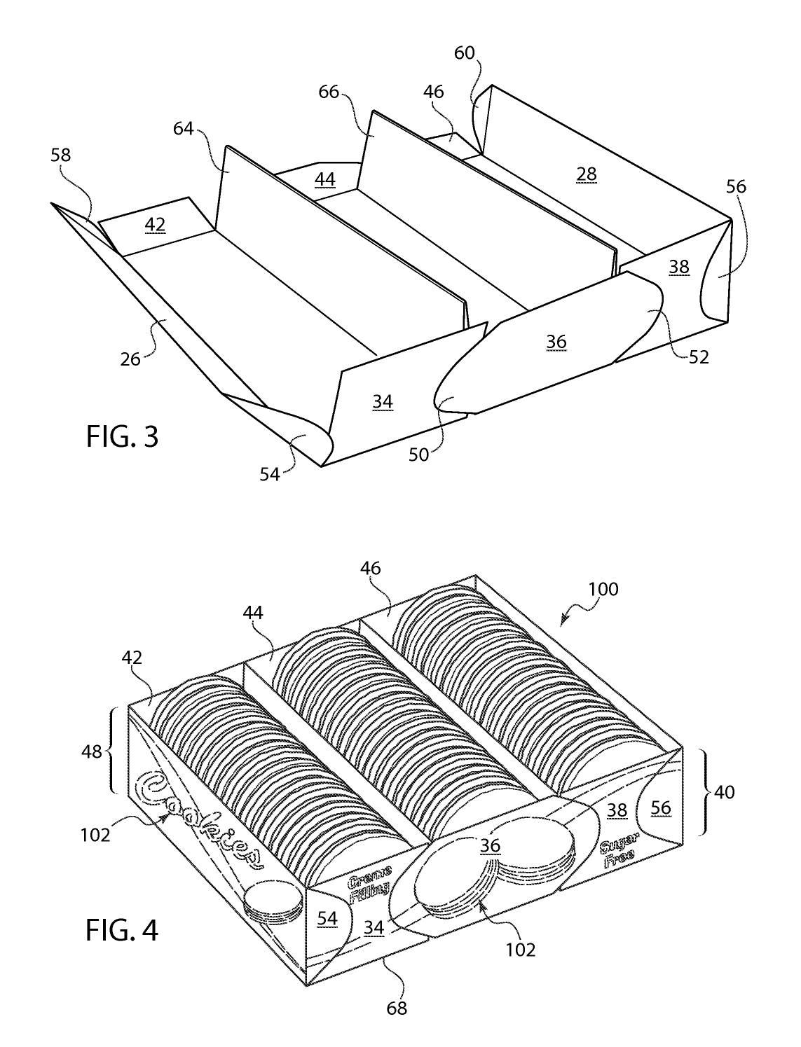

The blank 10 has a front end 30 and a back end 32. Along the front end 30 of each bottom panel 12, 14, 16 is a first end wall 35, 36, 38; and along the back end 32 of the each bottom panel 12, 14, 16 is a second end wall 42, 44, 46. In other words, each bottom panel has an end wall at its front end and another end wall at its back end. The first end walls 34, 36, 38 fold up in use to form the front wall 40 of the tray, and the second end walls 42, 44, 46 fold up in use to form the back wall 48 of the tray. In the embodiment shown in FIG. 1, the end walls 36, 44 of the middle bottom panel 14 have left and right extended features 50, 52 on either side of each end wall. As shown in FIG. 3, as the tray is assembled, the left extended feature 50 of end wall 36 overlaps end wall 34 and the right extended feature 52 of end wall 36 overlaps end wall 38 (in order to form the front wall 40). Similarly, the left extended feature 50 of end wall 44 overlaps end wall 42 and the right extended feature 52 of end wall 44 overlaps end wall 46 (in order to form the back wall 48). This overlapping covers the divisions or spaces that would inevitably occur between end walls without extended features 50, 52 in place.

Referring back to FIG. 1, along the front end 30 of each outer side panel 26, 28 is a first glue flap 54, 56, and along the back end 32 of the each outer side panel 26, 28 is a second glue flap 58, 60. In other words, each side panel has a glue flap at its front end and another glue flap at its back end. In use, glue flaps wrap around or overlap the side end walls in order to cover the division or corner space that would occur between the side end wall and the outer side panel.

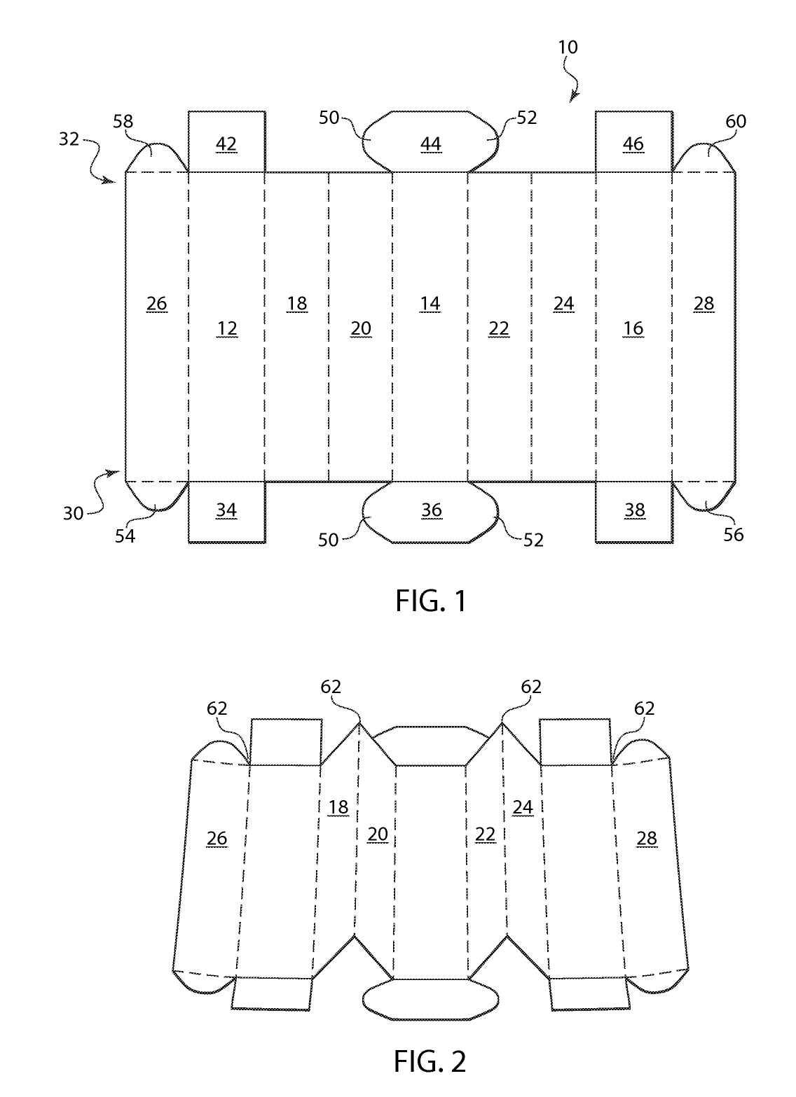

Each of the above-described panels are made distinct from one another by a dividing line 62, which may be a pre-folded line, a pre-formed crease line or fold, a line of weakness, or any other division or demarcation between panels that eases folding on-site, at the point of use, or elsewhere, during assembly of the tray. As shown in FIG. 2, the inner panels 18, 20 and 22, 24 will be folded along their respective dividing lines 62. This causes the inner panels to fold against one another, in order to create a first two-ply wall 64 (formed by panels 18 and 20) and a second two-ply wall (formed by panels 22, and 24). Outer side panels 26 and 28 are then folded up along their respective dividing lines 62, which creates the assembly shown in FIGS. 3 and 4.

FIG. 3 shows that end walls 34, 36, 38, are folded up to create the front wall 40. Specifically, the extended features 50, 52 of the middle end wall 36 overlap end walls 34 and 38. Glue flap 54 overlaps end wall 34 and glue flap 56 overlaps end wall 38. These flaps collectively form the front wall 40. Similarly, end walls 42, 44, 46 are folded up to create the back wall 48. The extended features 50, 52 of the middle end wall 44 overlap end walls 42 and 46. Although not clearly seen in FIG. 3, it is understood that glue flap 58 overlaps end wall 42 and glue flap 60 overlaps end wall 46. These flaps collectively form the back wall 48. Bottom panels 12, 14, 16 collectively form the tray base 68.

In short, the method for forming the tray may include providing the blank 10, which has nine panels separated from one another by pre-formed crease lines 62, with one or more of the panels have extending end walls or glue flaps. The panels are folded along the pre-formed crease lines 62 to form two separate 2-ply inner walls 64, 66, three bottom walls 12, 16, 18 (which collectively form the tray base 68), and two side walls of the tray 26, 28. The end walls are the folded up to create a front and back wall of the tray. Next, wrapping and securing glue flaps confines the tray in its assembled position.

Once all panels and flaps are folded into place, glue may be applied to the glue flaps and to the extended features in order to secure all panels and flaps in place. Additionally or alternatively, one or more of the end walls may have a slit or opening therein that is intended to received the extended features and the glue flaps. This allows assembly of the tray without the use of glue or other adhesive on the glue flaps or extended features. Instead, these portions are slid or tucked into slits on the end walls for securement.

The tray blank may be provided as a sheet of paperboard. It may be bleached board with a smooth or relatively smooth print surface. The paperboard is typically has a white-all-the-way through appearance, although it may be any color desired. It preferably has a consistent roll-to-roll quality. In certain embodiments, the paperboard has a grease resistant coating, or other food-safe, FDA-compliant coating that has been accepted for direct food contact applied thereto.

A further embodiment may provide a tray that has discrete cavities provided within one or more of the rows. For example, one or more cross dividers may be positioned cross ways within one or more of the rows in order to divide the row(s) into two or more compartments. In one embodiment, a separate partition may be positioned in the row. The partition may be positioned via a slit created in one of the inner panels that may receive a partition element tab. Alternatively, the partition may be glued into place. In a further embodiment, a partition flap may be formed via perforations on one or more of the inner panels, which may be punched out of place and bent or hinged across the row space in order to create a divider.

Trays that have one or more rows divided into one or more compartments may provide useful marketing and packaging options. For example, a cookie manufacturer may wish to sell its cookies undecorated, but provide frosting, sprinkles, and/or colored icing in the compartments for decoration by the consumer.

The formed tray is the three-row tray 100 shown in FIG. 4. Tray 100 may be used to hold food items, such as cookies, crackers, or any other appropriate item that lends itself to being stored in a paperboard tray. FIG. 4 also shows that tray 100 may be printed with marketing materials, promotional indicia, or any other printing, graphics, text, logo, brand name, or desired material 102. For example, the tray may be printed with the company name, their logo, or the items contained therein. Additionally or alternatively, the tray 100 may be printed with a holiday theme, such as snowflakes, Christmas trees, and stockings, or spring-time materials, such as flowers and umbrellas, and rabbits, or fireworks and picnic tablecloths, or for a baby or bridal shower. Any number of options are possible. One benefit to manufacturing blank 10 out of paperboard is that paperboard is easily-printable, and the tray can be customized to the desired look and feel. This may increase promotional efforts, leading to increased sales at certain times of the year. A hostess may select a printed tray wrapped in clear cellophane or other attractive wrapping to place on directly her buffet table, rather than removing the contents to place on a decorative tray. Tray 100 may thus serve as decorative tray in its own right.

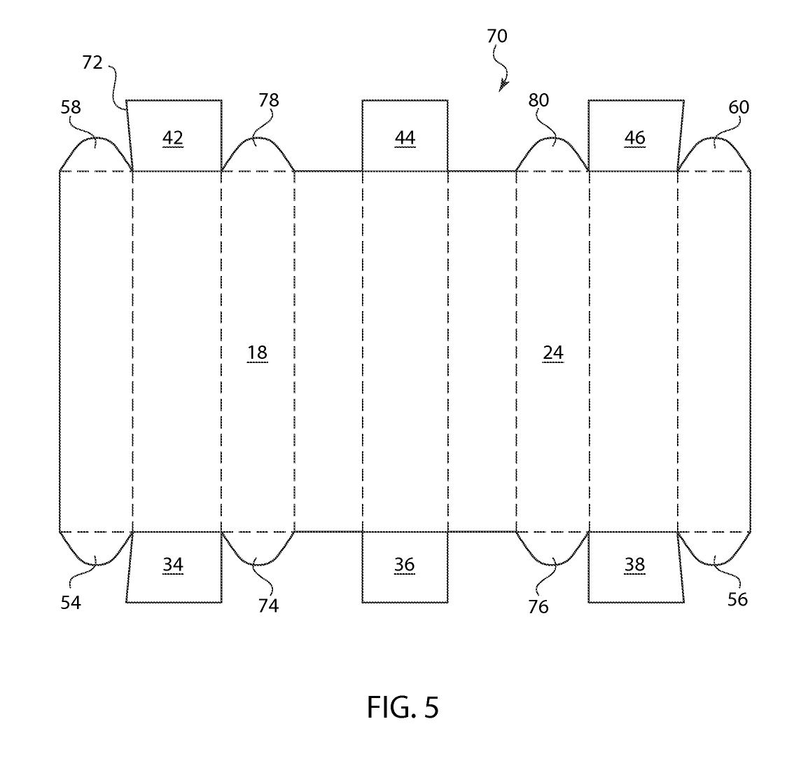

FIG. 5 shows an alternate embodiment of a blank 70. In blank 70, like reference numerals refer to the above description, but instead of extended features 50, 52 on the middle end walls 36, 44, all of the end walls are generally similarly sized. However, the outer (or side) end walls 34, 38, 42, 46 may have a slight outward taper 72. For example, the outward taper may be about a 5 degree taper, although any appropriate taper may be used. The primary intent for taper is to ease manufacturing. When the mandrel is stamping the blank 70, tapers 72 allow the mandrel to free itself from the formed blank easier. Although perfectly perpendicular sides may be used and are considered within the scope of the invention, the slight taper allows the blank to slide off of the mandrel easier, which can lower manufacturing time and costs. In order to compensate for the loss of extended features 50, 52, additional glue flaps 74, 76, 78, 80 are added to the inner panels 18 and 24. However, it should be understood that glue flaps may additionally or alternatively be added to inner panels 20 and 22. Glue flaps 74, 76, 78, 80 fold into, toward and overlap with middle end flaps 36 and 44. They may be secured with glue or they may be tucked into slits that may be formed into end walls.

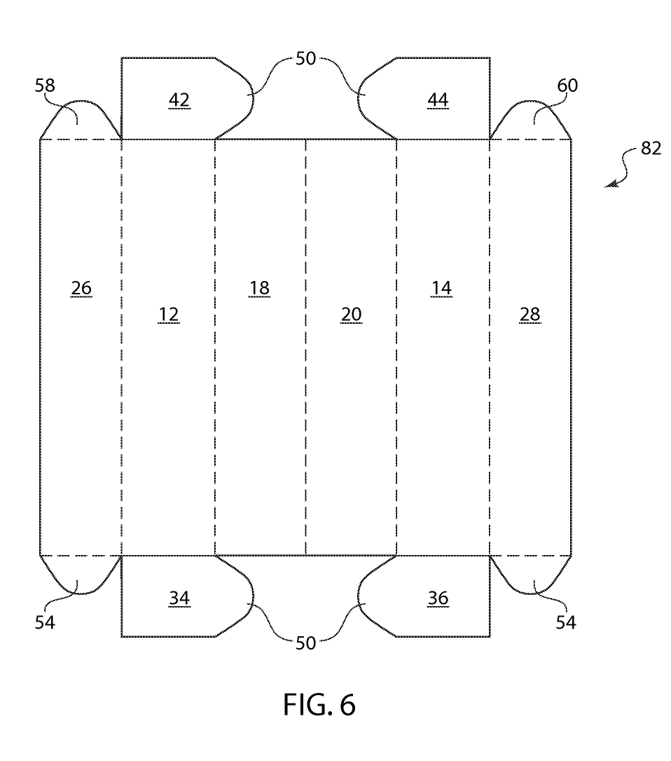

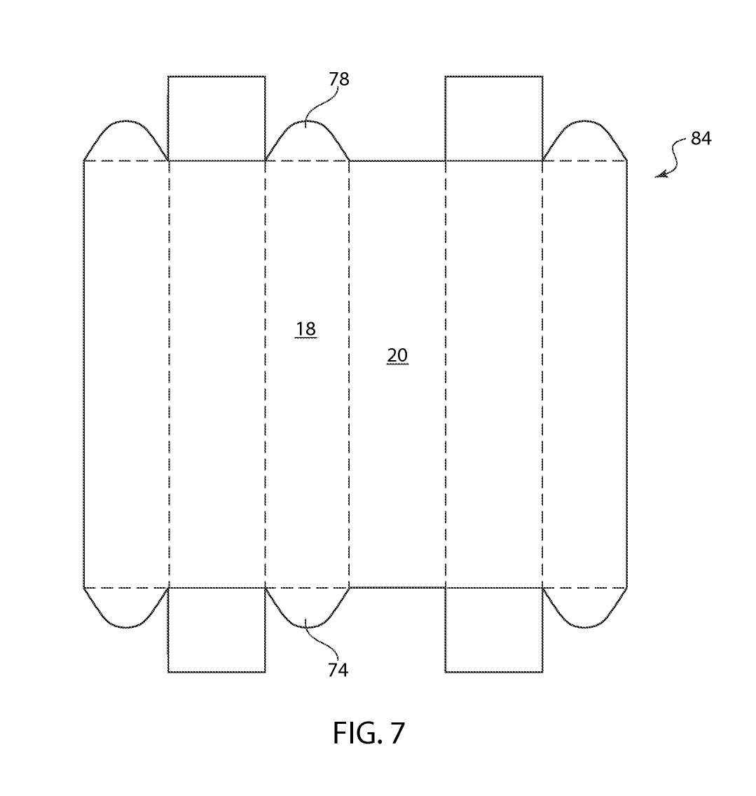

FIGS. 6-8 show alternate embodiments of tray blanks that may be used to form two-row trays. FIG. 6 shows on example of a blank 82 having only two bottom panels 12, 14 and only one set of inner panels 18, 20. Bottom panel 12 has end walls 34, 42 and bottom panel 14 has end walls 36, 44. Each of end walls have a single extended feature 50, although it should be understood that larger and differently-shaped features may be provided. Diving lines 62 are folded as described above and the folded blank 82 provides a two-row tray. FIG. 7 shows an alternate embodiment of blank 84, with glue flaps 74, 78 provided on inner panel 18 (although they could be additionally or alternatively provided on inner flap 20) instead of extended features 50 on end walls. End walls may all have perpendicular sides or they may be provided with the above-described slight taper.

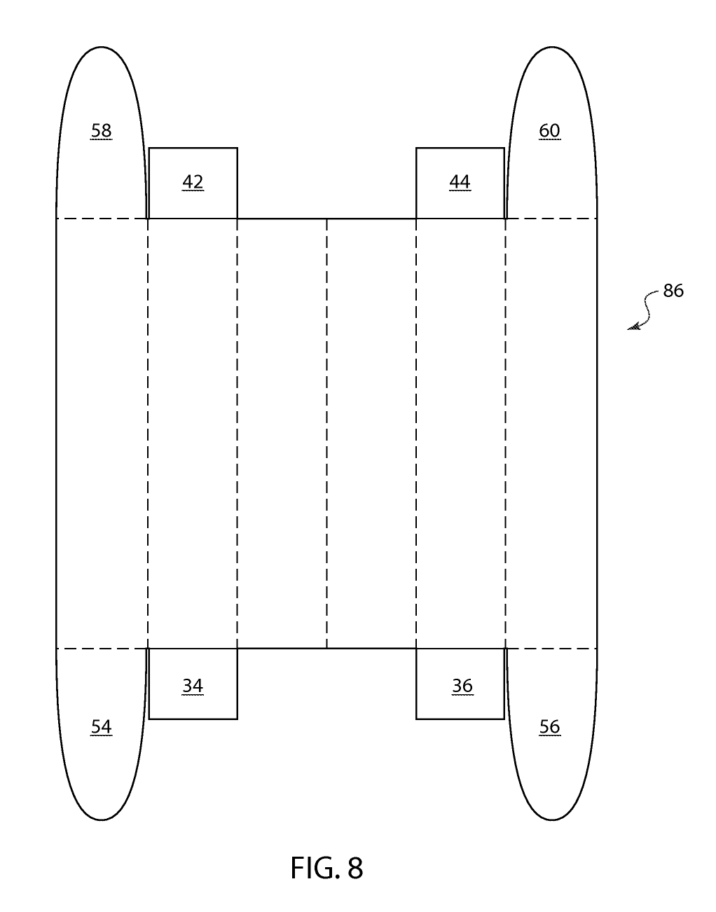

FIG. 8 shows an alternate blank 86. Blank 86 has extended glue flaps 54, 56, 58, 60 which are designed to wrap over end flaps 34, 36, 42, 44 in use to cover the gap or space between flaps when folded. This design removes the need for internal glue flaps and/or extended features on the end walls.

Because of the scalable nature of the invention, a design for blanks for trays having four, five six, or any number of additional rows would be apparent based on the descriptions provided herein and one could determine how to add additional inner panels and bottom panels in order to create many additional rows in a single tray. Changes and modifications, additions and deletions may be made to the structures and methods recited above and shown in the drawings without departing from the scope or spirit of the invention and the following claims.

What is claimed is:

1. A foldable tray blank comprising:
(a) at least six panels separated from one another by pre-formed crease lines,
(b) at least two of the panels forming bottom panels and having end walls extending therefrom;
(c) at least two of the panels comprising inner panels configured to abut one another to form a single 2-ply inner wall when folded; and
(d) two of the panels comprising outer side panels to form outer sides of a tray when the blank is folded.

2. The foldable tray blank of claim 1, wherein first and second end walls are positioned at each end of the at least two bottom panels.

3. The foldable tray blank of claim 1, wherein at least one of the end walls comprises an extended feature.

4. The foldable tray blank of claim 3, wherein the extended feature of one end wall is configured for being glued to an adjacent end wall when the blank is folded.

5. The foldable tray blank of claim 3, wherein at least one end wall comprises a slit for receiving the extended feature of an adjacent end wall when the blank is folded.

6. The foldable tray blank of claim 1, further comprising a glue flap positioned at each end of the two outer side panels.

7. The foldable tray blank of claim 1, further comprising a glue flap positioned at each end of one or more of the inner panels.

8. The foldable tray blank of claim 1, wherein the tray blank is formed of paperboard.

9. The foldable tray blank of claim 1, comprising three bottom panels, each having a front end and a back end, four inner panels, and the two outer side panels,
wherein the front end of each of the three bottom panels has an end wall extending therefrom, and wherein the back end of each of the three bottom panels has an end wall extending therefrom.

10. The foldable tray blank of claim 9, wherein all of the bottom panels, inner panels, outer side panels, and end walls are separated from one another along a pre-formed crease line.

11. The foldable tray of claim 9, wherein the three bottom panels are slightly larger than the four inner panel and the two outer side panels.

12. A foldable tray blank comprising:
nine panels separated from one another by pre-formed crease lines,
a first panel comprising a first outer side panel wall with glue flaps extending therefrom;
a second panel comprising a first bottom panel with end walls extending therefrom;
third and fourth panels comprising inner side walls that collectively form a first inner 2-ply wall when the blank is folded;
a fifth panel comprising a second bottom panel with end walls extending therefrom;
sixth and seventh panels comprising inner side walls that collectively form a second inner 2-ply wall when the blank is folded;
an eighth panel comprising a third bottom panel with end walls extending therefrom; and
a ninth panel comprising a second outer side panel wall with glue flaps extending therefrom.

13. The foldable tray blank of claim 12, wherein end walls of the fifth panel comprise extended features configured for being glued to an adjacent end wall when the blank is folded.

14. The foldable tray blank of claim 12, further comprising one or more glue flaps positioned adjacent one or more of the inner side walls or adjacent one or more of the end walls.

15. The foldable tray blank of claim 12, wherein the tray is formed of paperboard.

16. A method for forming a multi-row foldable tray, comprising:
(a) providing a blank having nine panels separated from one another by pre-formed crease lines, one or more of the panels have extending end walls or glue flaps;
(b) folding the panels along the pre-formed crease lines to form two separate 2-ply inner walls, three bottom walls, and two side walls of the tray;
(c) folding up end walls to create a front and back wall of the tray;
(d) wrapping and securing glue flaps.
